(19) United States
(12) Patent Application Publication
(10) Pub. No.: US 2025/0286060 A1
(43) Pub. Date: Sep. 11, 2025

(54) LITHIUM FERRO-PHOSPHATE (LFP) ELECTRODES WITH IMPROVED PROCESSIBILITY

(71) Applicant: GM GLOBAL TECHNOLOGY OPERATIONS LLC, Detroit, MI (US)

(72) Inventors: Bradley R. FRIEBERG, Farmington Hills, MI (US); Chuanlong WANG, Troy, MI (US); Mengyuan CHEN, Madison Heights, MI (US); Roland J. KOESTNER, Plymouth, MA (US); Xiaosong HUANG, Novi, MI (US); Nader Marandian HAGH, Southfield, MI (US); Kapila WADUMESTHRIGE, Macomb, MI (US)

(21) Appl. No.: 18/596,576

(22) Filed: Mar. 5, 2024

(51) Int. Cl. H01M 4/58; H01M 4/62

(52) U.S. Cl. CPC H01M 4/5825; H01M 4/623; H01M 4/625

(57) ABSTRACT

An electrode for a lithium-ion battery includes an electrochemically active material comprising lithium, an electrically conductive material comprising carbon; and a binder material comprising a polymer of molecular weight greater than 800 kilo-Dalton or polyvinylidene fluoride modified by an acid.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates generally to lithium-ion batteries and more particularly to lithium ferro-phosphate (LFP) electrodes with improved processibility for Lithium-ion batteries.

Lithium-ion batteries can be widely used in various applications. For example, lithium-ion batteries can be used to supply power to computing devices such as laptops, handheld devices (e.g., smartphones and tablets), and so on. Lithium-ion batteries can also be used to power vehicles such as electric vehicles (EVs), and so on.

### SUMMARY

An electrode for a lithium-ion battery comprises an electrochemically active material comprising lithium, an electrically conductive material comprising carbon; and a binder material comprising a polymer of molecular weight greater than 800 kilo-Dalton or polyvinylidene fluoride modified by an acid.

In other features, the electrode comprises 92-98.5 wt % of the electrochemically active material.

In other features, the electrode comprises 96-97.5 wt % of the electrochemically active material.

In other features, the electrode comprises 0.6-4 wt % of the electrically conductive material.

In other features, the electrode comprises 0.8-2 wt % of the electrically conductive material.

In other features, the electrode comprises 1-4 wt % of the binder material.

In other features, the electrode comprises 1.5-2.5 wt % of the binder material.

In other features, the electrochemically active material comprises a phosphate polyanion.

In other features, the electrochemically active material comprises a phosphate polyanion having a surface area greater than or equal to 6 m²/g.

In other features, the electrochemically active material comprises a phospho-olivine.

In other features, the electrochemically active material is selected from a group consisting of LiₓMPO₄, where M=Mn, Fe, Co, and Ni.

In other features, the electrochemically active material is selected from a group consisting of LiMnₓFe_{y}PO₄, where x+y=1.

In other features, the electrochemically active material is selected from a group consisting of LiFe(P₂O₇), LiFe₄(P₂O₇)₃, LiV₂(PO₄)₃, LiVOPO₄, LiV₂(PO₄)₃, and LiVPO₄F.

In other features, the conductive material is selected from a group consisting of carbon black (CB), acetylene black (AB) carbon, furnace black (FB) carbon, graphene nanoplatelet (GNP), carbon nanofiber (CNF), graphene (G), graphene oxide (GO), reduced graphene oxide (rGO), multi-wall carbon nanotube (MWCNT) and/or single-wall carbon nanotube (SWCNT), and blends thereof.

In other features, the electrically conductive material comprises acetylene black (AB) carbon and multi-wall carbon nanotube (MWCNT) or comprises furnace black (FB) carbon and multi-wall carbon nanotube (MWCNT).

In other features, the electrode comprises 96.5-97.25 wt % of the electrochemically active material.

In other features, the electrode comprises 1.5-2.1 wt % of the binder material.

In other features, the molecular weight of the polymer is greater than 800 kilo-Dalton and less than 1200 kilo-Daltan.

In other features, the polymer comprises acidic chemical functional groups along a polymer backbone with an acid content of more than 0.1 milliequivalents per gram of dry polymer.

In other features, the electrode comprises 1.0-1.6 wt % of the electrically conductive material.

In other features, the electrode comprises any combination or combinations of the formulations described above and below.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 shows an example of a lithium-ion battery;

FIG. 2 schematically shows a microscopic view of a particle of a cathode active material (CAM) such as lithium ferro-phosphate (LFP);

FIG. 3 shows a system for manufacturing an electrode;

FIG. 4 shows the adhesion strength for electrodes comprised of polymer binders with different molecular weights;

FIG. 5 shows the adhesion strength for electrodes comprised of different polymer binders;

FIG. 6 shows the improved electrical resistance of an LFP cathode with MWCNT addition to the conductive carbon package; and

FIG. 7 shows the improved capacity retention with charge cycling for an LFP cathode from FIG. 6.

In the drawings, reference numbers may be reused to identify similar and/or identical elements.

### DETAILED DESCRIPTION

Lithium-ion batteries can be of different types. For example, a lithium ferro-phosphate (LFP) battery uses LFP as an active material for cathode and graphitic carbon as anode. A lithium manganese ferro-phosphate (LMFP) battery uses a cathode that includes manganese as an additional component. In LFP batteries, a cathode is formed by preparing a slurry of an active material such as LFP, an additive such as an electrically conductive filler material, and a binder such as a polymer. The slurry is then dried to form the cathode.

The slurry and electrode processing as well as electrochemical performance of electrodes comprising of LFP particles present unique challenges due to high surface area (small primary particle size) and low intrinsic electrical conductivity of the electrode material. As a result, manufacturing LFP cathodes with good electrochemical and mechanical properties can be difficult. This is particularly prevalent for thicker electrodes for long range electric vehicle applications.

Specifically, processibility of LFP cathode slurries which have a low solids content of 35-45 wt % is challenging due to the high surface area (small primary particle size). The LFP cathode exhibits low intrinsic electrical conductivity, which hinders electrochemical performance. Energy density is measured in Watt-hours per kilogram (Wh/kg) and is an amount of energy a battery can store relative to a mass of the battery. To improve the electrical conductivity and increase the energy density, electrodes are commonly compressed to a higher gravimetric density. Compressing the LFP electrode to a high density (low porosity) is difficult due to delamination from the current collector or physical cracking of the coated layer. Accordingly, manufacturing LFP cathodes having desired electrochemical and mechanical properties is difficult.

The present disclosure provides a formulation for LFP electrodes that improves the slurry processibility, electrode durability, and compressibility. The electrode formulation also minimizes (lowers) the internal resistance to improve the electrochemical performance of the LFP electrodes. The electrode formulation solves the above problems by forming the LFP cathode using a unique combination of polymer binder and conductive carbon additives to increase the solids content of the slurry up to >55 wt % and to compress the resulting electrode coating to as low as 25 vol % porosity (i.e., high density). The electrode formulation maximizes the amount of the active material without compromising the durability and electrical conductivity of the electrode. Accordingly, the resulting LFP cathode exhibits improved electrochemical and mechanical properties as described below in detail.

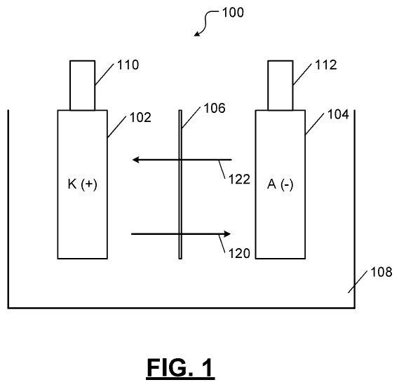

FIG. 1 schematically shows an example of a lithium-ion battery 100. The lithium-ion battery 100 comprises a cathode (K+) 102, an anode (A−) 104, a separator 106, an electrolyte 108, and current collectors 110, 112. The cathode 102 is the positive electrode. The anode 104 is the negative electrode. During charging, lithium ions flow from the cathode 102 to the anode 104 through the separator 106 and the electrolyte 108 as shown by arrow 120. During discharging (i.e., supplying power from the lithium-ion battery 100 to a load), lithium ions flow from the anode 104 to the cathode 102 through the separator 106 and the electrolyte 108 as shown by arrow 122.

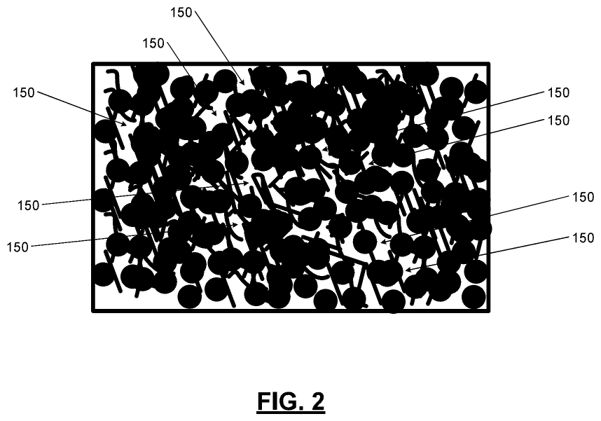

FIG. 2 schematically shows a microscopic view of a typical LFP cathode active material (CAM) before processing (i.e., before adding the solvent, binder, and conductive carbon). The active material has low intrinsic electrical conductivity. The smaller LFP primary particles (e.g., 100-400 nm in size) are sintered into a secondary structure with larger particles (e.g., 5-20 microns in diameter). The high surface area of the primary particles provides a significant interfacial area for charge-transfer to the electrolyte solution and a shorter solid-state diffusion path for Lithium ions, and the larger secondary structure provides improved slurry processability. The electrode thereby comprises many void spaces 150 between and within the secondary structure to enable efficient ionic transport Lithium (Li) transport to the electrochemically active site.

During processing, a solvent and a polymer binder flow into the void spaces 150. Due to the internal void spaces 150 within the LFP secondary structure, more solvent and polymer binder are needed. Higher solvent content means lower slurry solids content and increased drying time (lower manufacturing speed). When an electrode with a higher solvent content is dried rapidly, it can also cause cracking of the electrode. Further, if polymer binder imbibes within the LFP secondary structure, less binder remains to provide particle-to-particle cohesion which leads to poor durability/flexibility of the electrode. A higher polymer binder content improves the durability and flexibility of the electrode. On the other hand, higher polymer binder content further reduces the electrode energy density and increases the internal resistance since the polymer binder also has low electrical conductivity. To reduce the electrical resistance of the polymer binder, conductive carbon additives are included, which further reduces the energy density. The electrode formulation of the present disclosure solves these problems as follows.

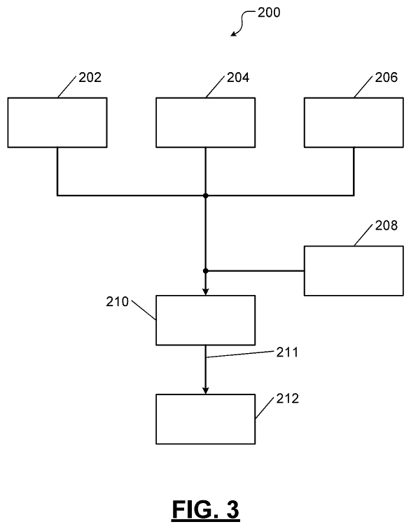

FIG. 3 shows a system 200 for manufacturing a LFP cathode according to the present disclosure. An active material (e.g., LFP) 202, a conductive filler (additive) 204, and a polymer binder 206 are mixed with a solvent 208 in a mixer (not shown) to form a slurry 210 until the slurry 210 become viscous. The viscous slurry 210 is spread on an aluminum current collector and dried (shown by arrow 211) to form the LFP cathode (electrode) 212. The dried material is then cut to form LFP cathodes (electrodes) 212 of various sizes. The LFP cathode of the present disclosure is formed using the following polymer binders and conductive fillers, which solves the problems described above.

For example, the solvent used to form the electrode slurry comprises N-methyl pyrrolidone (NMP). For example, the polymer binder comprises a functionalized polyvinylidene fluoride (PVDF) homopolymer. The PVDF is functionalized (treated) to improve adhesion and reduce gelation of the slurry with time (i.e., to increase viscosity with time). A functionalized polymer binder improves the cohesion between LFP particles and adhesion to the current collector, which in turn improves the durability of the LFP cathode. A functionalized polymer binder allows using a lower binder content, which improves the energy density. For example, the PVDF is functionalized (treated) using acid functionalization (treatment). For example, the acids used to functionalize (treat) the PVDF may comprise carboxylated or sulfonated comonomers along the polymer backbone.

For example, the conductive filler comprises a combination of carbon black (CB) and carbon nanotubes (CNT) to improve the conductivity of the LFP cathode. The combination of carbon black (CB) and carbon nanotubes (CNT) improves the electrical conductivity within the carbon-binder domain surrounding the LFP secondary structures. The primary carbon particle within the structured CB aggregate has a smaller diameter (e.g., 10-40 nanometers) than the active LFP material (e.g., 5-20 microns). The smaller diameter of the primary carbon particles within the structured CB aggregate (CB particles) provides many points of contact. The conductive particles provide short-range electrical connections (paths) between the particles of the active material (LFP). The CNTs can be long (e.g., up to a few microns). For example, a length to diameter ratio of the CNTs can be greater than 30. The CNTs provide long-range electrical connections (paths). The CB particles provide connections (electrical paths) for the particles of the active material (LFP) to the CNTs. The CB particles connect the particles of the active material (LFP) through the short-range electrical connections (paths) to the long-range electrical connections (paths) provided by the CNTs. Thus, the CB particles and the CNTs increase the electrical conductivity between the particles of the active material (LFP).

The following are examples of various formulations for manufacturing cathodes according to the present disclosure, which solve the problems described above. A cathode formulation using phosphate polyanions (or their blends) as active material combined with high aspect ratio conductive fillers and binders such as modified PVDF and other high molecular weight polymers according to the present disclosure can comprise the materials described below. The cathode formulation provides the following technical advantages: 1) Increased solids content of the slurry to >55 wt %, which means using less solvent with improved drying time (increased manufacturing speed). 2) Decreased electrode resistance (i.e., electrical and charge transfer resistance) and improved long term cycle life. 3) Improved compressibility leading to high energy density cell (mechanical strength and durability) while using less of expensive electrolyte.

The active materials in the formulations comprise a class of materials called phosphate polyanions (or their blends). The class of active materials can comprise any of the following: 1) A high surface area phosphate polyanion (e.g., ≥6 m²/g). 2) Phospho-olivines, LiₓMPO₄ (where M=Mn, Fe, Co, Ni, etc. or combinations thereof) such as LiFePO₄ (LFP) and LiMnₓFe_{y}PO₄ (LMFP), where x+y=1. 3) Other examples of phosphate polyanions comprising LiFe(P₂O₇), LiFe₄(P₂O₇)₃, LiV₂(PO₄)₃, LiVOPO₄, LiV₂(PO₄)₃, and LiVPO₄F. The content amount of the active material can be 92-98.5% (e.g., 96-97.5%), where % is wt %.

For example, the LFP cathode active material (CAM) used in this disclosure has a primary particle diameter of 150-250 nm and a spheroidal secondary aggregate of a median diameter of 8-13 microns. The CAM also has an internal porosity of ˜13% v/v for the secondary aggregate. Throughout the present disclosure, the symbol means about or approximately (i.e., indicates a range between ±0.5% to ±5%).

The polymer binders in the formulations comprise a class of materials as follows. 1) A high molecular weight PVDF binder with M_{w}>800 kilo-Dalton (kD) but <1200 kD. 2) A PVDF binder with a melt pointing at Tₘₑₗₜ>160° C. to improve film strength and reduce electrolyte swell. 3) An acid-functionalized PVDF with meq acid/g polymer>0.10 to improve cohesion between particles, adhesion to the aluminum current collector, and prevent gelation of the slurry with time (e.g., modified by using carboxylated or sulfonated comonomers). The ion exchange capacity is expressed in milliequivalents per gram (meq g⁻¹) of dry ionomer in HW form. The content amount of the binder can be 0.75-4 wt % (e.g. 1.5-2.5 wt %). The PVDF binders used in this application are listed in Table 1.

TABLE 1
PVDF binder polymers described in this disclosure.
Polymer Property

| | | | | Acid loading |
|---|---|---|---|---|
| Label | Composition | M_{w} (kD) | Tₘₑₗₜ (degC.) | (meq/g) |
| PVDF #1 | Homopolymer | 500 | 163 | 0.00 |
| PVDF #2 | Homopolymer | 1000 | 163 | 0.00 |
| PVDF #3 | Homopolymer | 1360 | 163 | 0.00 |
| PVDF #4 | Functionalized | 990 | 163 | 0.34 |
| | homopolymer | | | |
| PVDF #5 | Functionalized | 1070 | 131 | 0.13 |
| | copolymer | | | |

The conductive fillers in the formulations comprise a class of materials as follows. A combination of conductive additives including carbon black (CB), acetylene black (AB) carbon (simply called AB), furnace black (FB) carbon (simply called FB), graphene nanoplatelet (GNP), carbon nanofiber (CNF), graphene (G), graphene oxide (GO), reduced graphene oxide (rGO), multi-wall carbon nanotube (MWCNT) and/or single-wall carbon nanotube (SWCNT), and their blends. The content amount of the conductive filler can be 0.6-4% (e.g., 1-2%), where % is wt %. The physical properties of the conductive carbon additives used in this application are listed in Tables 2 and 3.

TABLE 2
Carbon black powders described in this disclosure.

| Carbon Black Property | FB | AB | KB |
|---|---|---|---|
| Composition | CB #1 | CB #2 | CB #3 |
| | (furnace | (acetylene | (Ketjen |
| | black) | black) | black) |
| Aggregate Diameter | ~100 | ~100 | ~100 |
| (D, nm) | | | |
| Aggregate Length | ~200 | ~200 | ~200 |
| (L, nm) | | | |
| Aspect ratio (L/D) | ~2 | ~2 | ~2 |
| Primary Particle | 40 | 20 | 20 |
| Diameter (nm) | | | |
| Surface area (m²/g) | 65 | 140 | 1600 |

TABLE 3
Carbon nanotube dispersions described in this disclosure.

| Carbon Nanotube Property | MWCNT 1 | MWCNT 2 | SWCNT |
|---|---|---|---|
| # of Walls | ~6-7 | ~6-7 | ~1-2 |
| Diameter (D, nm) | ~10 | ~10 | ~2 |
| Length (L, nm) | ~120 | ~5000 | ~5000 |
| Aspect ratio (L/D) | ~12 | ~500 | ~2500 |
| Surface area (m²/g) | ~300 | ~300 | ~400 |

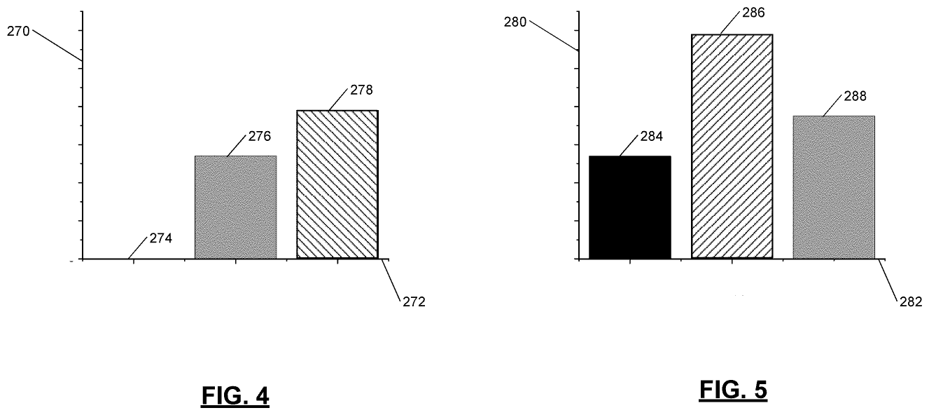

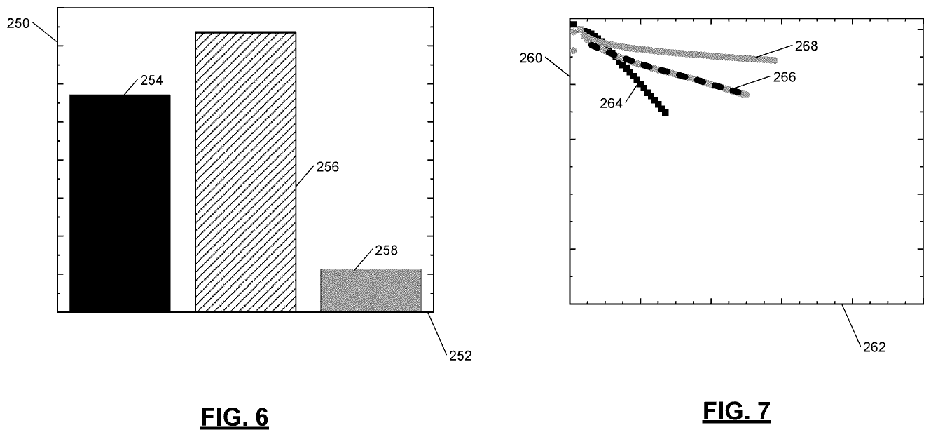

FIGS. 4-7 graphically show the inventive combination of both conductive carbon and PVDF binder packages for an LFP cathode coating to increase peel strength (FIGS. 4 and 5), reduce electrical resistance (FIG. 6), and cycle life (FIG. 7). In the following description, while FB is not discussed separately, using FB instead of AB provides results comparable to when AB is used instead, although using AB as described below provides better results than using FB instead of using AB.

FIG. 4 shows the impact of the molecular weight of the polymer binder on the adhesion and durability of the LFP electrode and slurry viscosity. The peel strength is shown on the Y-axis at 270, and molecular weight of the polymer binder is shown on the X-axis at 272. Peel strength is the amount of force per unit width required to feel off the material from the current collector.

In FIG. 4, each of the LFP cathodes comprises 95.5% LFP, and a combination of carbon-based conductive fillers AB 0.5% and CNT 1% MWCNT. The amounts of the active material (LFP) and the conductive fillers are the same in each of the three LFP electrodes. The molecular weights of the polymer binders differ in each of the 3 electrodes as follows.

In FIG. 4, the LFP electrode with peel strength shown at 274 comprises a low molecular weight (PVDF1) polymer binder. The LFP electrode with peel strength shown at 276 comprises a high molecular weight (PVDF2) polymer binder. The LFP electrode with peel strength shown at 278 comprises an ultra-high molecular weight (PVDF3) polymer binder. PVDF1<PVDF2<PVDF3. For example, PVDF1˜500 kDa, PVDF2˜1000 kDa, and PVDF3˜1370 kDa. The peel strength scales with the molecular weight of the homopolymer binder. The LFP electrode formulations used in this disclosure are summarized in Table 4. Slurry #1 is commonly used, exhibits the problems described above, and is therefore not described below. Throughout the following description, the terms PVDFn and PVDF #n are used interchangeably and synonymously, where n=1, 2, 3, or 4.

TABLE 4
LFP electrode slurry formulations described in this disclosure.

| | | | | | | |
|---|---|---|---|---|---|---|
| | | | | | | Charge |
| | | | Conductive | Electrical | Ionic | Transfer |
| | | Polymer | Carbon | Resistance | Resistance | Resistance |
| Composition | LFP | Binder | Additive | (Ohm cm²) | (Ohm cm²) | (Ohm cm²) |

Comparative examples

| | | | | | | |
|---|---|---|---|---|---|---|
| Slurry #1 | 95.5% | 3.0% | 0.5% AB | — | — | — |
| | | PVDF1 | 1.0% | | | |
| | | | MWCNT | | | |
| Slurry #2 | 95.5% | 3.0% | 0.5% AB | 10.2 | 9.0 | 13.4 |
| | | PVDF2 | 1.0% | | | |
| | | | MWCNT | | | |
| Slurry #3 | 95.5% | 3.0% | 0.5% AB | 9.9 | 7.9 | 10.2 |
| | | PVDF3 | 1.0% | | | |
| | | | MWCNT | | | |
| Slurry #6 | 95.5% | 3.0% | 1.5% AB | 114.3 | 15.0 | 16.0 |
| | | PVDF2 | | | | |
| Slurry #7 | 95.5% | 3.0% | 1.0% AB | 116.2 | 15.0 | 17.9 |
| | | PVDF2 | 0.5% KB | | | |

Inventive Examples

| | | | | | | |
|---|---|---|---|---|---|---|
| Slurry #4 | 95.5% | 3.0% | 0.5% AB | 5.1 | 6.6 | 15.9 |
| | | PVDF4 | 1.0% | | | |
| | | | MWCNT | | | |
| Slurry #5 | 96.4% | 2.1% | 0.5% AB | 3.4 | 8.5 | 5.7 |
| | | PVDF4 | 1.0% | | | |
| | | | MWCNT | | | |
| Slurry #8 | 96.4% | 2.1% | 0.5% CB | 4.8 | 6.1 | 4.5 |
| | | PVDF4 | 1.0% | | | |
| | | | MWCNT | | | |
| Slurry #9 | 96.4% | 2.1% | 1.0% CB | 5.7 | 6.9 | 11.9 |
| | | PVDF4 | 0.5% | | | |
| | | | MWCNT | | | |

While not shown, slurry #2 with the high molecular weight polymer binder exhibits lower viscosity than slurry #3 comprising the polymer binder of ultra-high molecular weight (PVDF3) at the same solids content. Additionally, while not shown, electrodes formed using slurry #2 and coated with the high molecular weight (PVDF2) polymer binder exhibits longer cycle life than the LFP electrode formed using slurry #3 and coated with the polymer binder of ultra-high molecular weight.

Thus, using a polymer binder of low molecular weight (PVDF1) allows forming the slurry with less solvent (high solids content), which is easy to process and fast-drying, but has the weakest peel strength (poorest mechanical durability). Using a polymer binder of ultra-high molecular weight (PVDF3) requires using more solvent (low solids content) to process the slurry, which takes longer to dry, but has the strongest peel strength (highest mechanical durability). Accordingly, using a polymer binder of high molecular weight (PVDF2) provides a good balance between peel strength (medium solids content, and highest mechanical durability) and cycle life (high) than using the polymer binder of low molecular weight (PVDF1) and the polymer binder of ultra-high molecular weight (PVDF3).

In FIG. 5, the peel strength of three LFP electrodes are shown at 284 (Slurry #2), 286 (Slurry #4) and 288 (Slurry #5). In FIG. 5, the peel strength is shown on the Y-axis at 280, and LFP cathodes comprising different modified PVDF binders are shown on the X-axis at 282. Each of the three LFP cathodes comprises a combination of carbon-based conductive fillers AB 0.5% and CNT 1% MWCNT. Each of the LFP electrodes shown at 284 and 286 comprises 95.5% LFP. The LFP electrode shown at 288 comprises 96.4% LFP. The PVDF binders differ in each of the three LFP cathodes as follows.

The LFP electrode shown at 284 comprises 3% of homopolymer PVDF #2 as binder. The LFP electrode shown at 286 comprises 3% of a modified PVDF called PVDF #4 (modified or functionalized using acid treatment as described above) as binder. The LFP electrode shown at 288 comprises only 2.1% of PVDF #4.

The electrode comprising of the modified PVDF (Slurry #4) exhibits twice the adhesion strength as an electrode with unmodified PVDF of equivalent molecular weight and binder content (Slurry #2). Additionally, in a formulation comprising the modified PVDF, the binder content can be reduced to 2.1% (Slurry #5) and yet maintain a higher peel strength and energy density. The acid modification improves the adhesive properties of the polymer binder to both the LFP particle surface and aluminum current collector.

The cycle life of the LFP electrode formed using Slurry #2 comprising 3% unmodified PVDF shown at 284 is greater than the cycle life of the LFP electrodes shown at 286 and 288. The cycle life of the LFP electrode formed using Slurry #4 comprising 95.5% LFP and 3% PVDF #4 shown at 286 is only slightly greater than the life cycle of the LFP electrode formed using Slurry #5 comprising 96.4% LFP (increased amount of active material), and 2.1% PVDF #4 (decreased amount of the binder) shown at 288.

Accordingly, using the formulation of 96.4% LFP (increased amount of active material), a combination of carbon-based conductive fillers AB 0.5% and CNT 1% MWCNT, and 2.1% PVDF2 (decreased amount of the binder) provides not only good peel strength as shown at 288 but also good cycle life performance.

In FIG. 6, electrical resistances of LFP cathodes comprising different carbon-based conductive fillers are shown. The resistance is shown on the Y-axis 250. The different carbon-based conductive fillers are shown on the X-axis at 252. The resistance of an LFP cathode formed using slurry #6 comprising the carbon-based conductive filler acetylene black (AB) is shown at 254. The resistance of an LFP cathode formed using slurry #7 comprising a combination of carbon-based conductive fillers acetylene black (AB and Ketjenblack (KB) (i.e., AB+KB) is shown at 256. The resistance of an LFP cathode formed using slurry #2 comprising a combination of carbon-based conductive fillers acetylene black (AB) and MWCNT (I.e., AB+CNT) is shown at 258.

In FIG. 6, each of the three LFP cathodes comprises 95.5% LFP and 3% PVDF2 binder. The amounts of the active material (LFP) and the binder are the same in each of the three LFP electrodes. The amounts of the carbon-based conductive fillers are also the same but the compositions of the carbon-based conductive fillers differ in each of the three LFP cathodes as follows. In the LFP electrode shown at 254, the amount of AB is 1.5% (Slurry #6). In the LFP electrode shown at 256, the amount of AB is 1% and the amount of KB is 0.5% (Slurry #7). In the LFP electrode shown at 258, the amount of AB is 0.5% and the amount of CNT is 1% (CNT is MWCNT) (Slurry #2).

The LFP electrode comprising 95.5% LFP, 3% PVDF binder, AB 0.5%, and CNT 1% MWCNT shown at 258 exhibits much lower resistance (greater conductivity) than the LFP electrode comprising 95.5% LFP, 3% PVDF binder, 1.5% AB shown at 254 and the LFP electrode comprising 95.5% LFP, 3% PVDF binder, AB 1%, and KB 0.5% shown at 256.

The LFP electrode comprising 95.5% LFP, 3% PVDF binder, 1.5% AB shown at 254 exhibits higher resistance (lower conductivity) than the LFP electrode comprising 95.5% LFP, 3% PVDF binder, AB 0.5%, and CNT 1% MWCNT shown at 258 but exhibits lower resistance (higher conductivity) than the LFP electrode comprising 95.5% LFP, 3% PVDF binder, AB 1%, and KB 0.5% shown at 256.

The cycle life of the three LFP electrodes is shown in FIG. 7. The amount of charge retained (retention) is shown on the Y-axis at 260. The cycle life improves for slurry #5 that has the lowest internal electronic resistance in FIG. 6 and Table 5.

Thus, the LFP electrode shown at 258 exhibits both lower resistance and higher cycle life (charge retention) than the LFP electrodes shown at 254, 256. The LFP electrode shown at 254 exhibits higher resistance and lower cycle life than the LFP electrode shown at 258. Accordingly, a combination of conductive fillers (additives) with different aspect ratios (AB vs. CNT) improves the electrochemical performance of the LFP electrodes. Specifically, adding the combination of the carbon-based conductive fillers AB 0.5% and MWCNT 1% in the formulation of the LFP electrode comprising 95.5% LFP and 3% PVDF binder improves the electrochemical performance.

Table 4 lists the formulations described in this disclosure and additional formulations and lists their measured internal resistances, ionic resistances, and charge transfer resistances. Table 4 demonstrates that the electronic and charge transfer resistances dominate the electrode resistance. Additional examples of electrodes with improved electrochemical performance such as slurry #8 and slurry #9, which comprise CB and MWCNT and PVDF4 are also listed. Table 4 shows that LFP electrodes formed using slurries 4, 5, 8, and 9 provide much lower resistances than other slurries.

Thus, in the examples shown and described with reference to FIGS. 4-7 above, in the formulations for LFP electrodes according to the present disclosure, the active material content can be increased, the content of the binder can be decreased, the binder can comprise an acid-functionalized ultra-high molecular weight polymer, and the conductive additive can be a combination AB (or FB) and MWCNT. The formulations provide good mechanical and electrochemical properties as described above.

The formulation are described above with reference to LFP as active material. The above teachings apply equally to any active material in the entire class of active materials listed or described above with reference to phosphate polyanions (or their blends). As a non-limiting example, the above teachings apply equally to LMFP and other active materials listed or described above.

The foregoing description is merely illustrative in nature and is not intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims.

It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure. As used herein, the phrase at least one of A, B, and C should be construed to mean a logical (A OR B OR C), using a non-exclusive logical OR, and should not be construed to mean “at least one of A, at least one of B, and at least one of C.”

What is claimed is:

1. An electrode for a lithium-ion battery comprising:
an electrochemically active material comprising lithium;
an electrically conductive material comprising carbon; and
a binder material comprising a polymer of molecular weight greater than 800 kilo-Dalton or polyvinylidene fluoride modified by an acid.

2. The electrode of claim 1 comprising 92-98.5 wt % of the electrochemically active material.

3. The electrode of claim 1 comprising 96-97.5 wt % of the electrochemically active material.

4. The electrode of claim 1 comprising 0.6-4 wt % of the electrically conductive material.

5. The electrode of claim 1 comprising 0.8-2 wt % of the electrically conductive material.

6. The electrode of claim 1 comprising 1-4 wt % of the binder material.

7. The electrode of claim 1 comprising 1.5-2.5 wt % of the binder material.

8. The electrode of claim 1 wherein the electrochemically active material comprises a phosphate polyanion.

9. The electrode of claim 1 wherein the electrochemically active material comprises a phosphate polyanion having a surface area greater than or equal to 6 m²/g.

10. The electrode of claim 1 wherein the electrochemically active material comprises a phospho-olivine.

11. The electrode of claim 1 wherein the electrochemically active material is selected from a group consisting of LiₓMPO₄, where M=Mn, Fe, Co, and Ni.

12. The electrode of claim 1 wherein the electrochemically active material is selected from a group consisting of LiMnₓFe_{y}PO₄, where x+y=1.

13. The electrode of claim 1 wherein the electrochemically active material is selected from a group consisting of LiFe(P₂O₇), LiFe₄(P₂O₇)₃, LiV₂(PO₄)₃, LiVOPO₄, LiV₂(PO₄)₃, and LiVPO₄F.

14. The electrode of claim 1 wherein the conductive material is selected from a group consisting of carbon black (CB), acetylene black (AB) carbon, furnace black (FB) carbon, graphene nanoplatelet (GNP), carbon nanofiber (CNF), graphene (G), graphene oxide (GO), reduced graphene oxide (rGO), multi-wall carbon nanotube (MWCNT) and/or single-wall carbon nanotube (SWCNT), and blends thereof.

15. The electrode of claim 1 wherein the electrically conductive material comprises acetylene black (AB) carbon and multi-wall carbon nanotube (MWCNT) or comprises furnace black (FB) carbon and multi-wall carbon nanotube (MWCNT).

16. The electrode of claim 1 comprising 96.5-97.25 wt % of the electrochemically active material.

17. The electrode of claim 1 comprising 1.5-2.1 wt % of the binder material.

18. The electrode of claim 1 wherein the molecular weight of the polymer is greater than 800 kilo-Dalton and less than 1200 kilo-Daltan.

19. The electrode of claim 1 wherein the polymer comprises acidic chemical functional groups along a polymer backbone with an acid content of more than 0.1 milliequivalents per gram of dry polymer.

20. The electrode of claim 1 comprising 1.0-1.6 wt % of the electrically conductive material.
